(19) United States
(12) Patent Application Publication
(10) Pub. No.: US 2023/0370759 A1
(43) Pub. Date: Nov. 16, 2023

(54) SELF-SEALING EAR-TIP FOR IN-EAR HEADPHONES

(71) Applicant: HARMAN INTERNATIONAL INDUSTRIES, INCORPORATED, Stamford, CT (US)

(72) Inventors: Omid KHONSARIPOUR, Thousand Oaks, CA (US); Todd S. WELTI, Thousand Oaks, CA (US)

(21) Appl. No.: 18/246,484

(22) PCT Filed: Aug. 31, 2021
(86) PCT No.: PCT/US2021/048513

§ 371 Date: Mar. 23, 2023

Related U.S. Application Data
(60) Provisional application No. 63/082,309, filed on Sep. 23, 2020.

(51) Int. Cl. H04R 1/10; H04R 25/00

(52) U.S. Cl. CPC H04R 1/1016; H04R 25/652

(57) ABSTRACT

In some embodiments, an apparatus includes an audio generating element; a sleeve including a longitudinal channel, an outer surface of the sleeve including at least a first portion that is expandable in a cross-sectional size in at least one direction; and a rigid insert configured for insertion into the longitudinal channel. At least the first portion of the outer surface of the sleeve expands in the at least one direction when the rigid insert is inserted into the longitudinal channel.

### CROSS-REFERENCES TO RELATED APPLICATIONS

This application claims the priority benefit of United States provisional application titled, “SELF-SEALING EAR-TIP FOR IN-EAR HEADPHONES,” filed on Sep. 23, 2020, and having Ser. No. 63/082,309. The subject matter of this related application is hereby incorporated herein by reference.

### BACKGROUND

### Field of the Various Embodiments

The present disclosure is directed to in-ear headphones and, more particularly, to a self-sealing ear-tip for in-ear headphones.

### Description of the Related Art

In-ear headphones are designed for insertion into the ear canal of a user. An earbud including a speaker or other transducer that outputs audio from an audio source, such as a mobile phone, is inserted directly into the ear canal of the user. As compared with on-ear or over-ear headphones, earbuds are smaller, lighter, and more discreet. In-ear headphones also provide the advantages of improved privacy due to reduced leakage of the audio to the environment, and/or improved sound quality due to reduced ambient noise perceived by the user.

Some earbuds are made of a flexible material, such as silicone, neoprene, or rubber. These earbuds are designed with a shape such as a cylinder, cone (“Christmas-tree type”), or bulb (“mushroom type”), and are retained in the ear canal through friction or surface tackiness. Other earbuds are made of an elastic material, such as memory foam, which can be compressed in a cross-sectional size in at least one direction (e.g., a radius or width-wise direction) for insertion into and removal from the ear. Releasing the compression causes the memory foam to expand and to fill the ear canal.

However, these designs of earbuds exhibit some disadvantages. First, each earbud can be poorly fit to the ear canal of a user due to differences between the shape and/or dimensions of the inserted earpiece and the ear canal. As a result, one or both earbuds can be too wide for the ear canal, resulting in discomfort and/or difficulty while inserting, wearing, and/or removing the earbud. Second, an earbud can be too narrow for the ear canal, resulting in reduced retention that causes the earbud to dislodge. Poor retention can be exacerbated during physical activity of the user, such as running, bicycling, or swimming. Third, the shapes of each earbud and the ear canal can cause the earbud to migrate within the ear canal to a depth at which the fit maximally conforms. In some cases, this depth can be either too deep or too shallow for the comfort and retention, but it can be difficult for the user to retain the earbud at a different depth. Fourth, some earbud designs include removable ear-tips of different sizes to match the sizes of the ear canals of different users. However, the ear-tips are typically available only in a fixed and limited number of sizes, and the shapes of the ear-tips are typically consistent and uniform. As a result, a particular user might be unable to find any ear-tip that fits his or her ear canal. Further, the removable ear-tips can be misplaced, and can be inconvenient to attach or detach.

Second, due to differences in the shapes of ear canals of different users, earbuds that are comfortable and well-fit for a first user can be uncomfortable or poorly fit for a second user. Earbuds that do not adapt to the ear canal of the user can result in an unsatisfying fit or retention.

Third, an incomplete fit between the shape of the earbud and the ear canal can result in leakage of audio. In particular, leakage can be greater for some frequencies, such as frequencies in a bass or sub-bass frequency range, than for other frequencies, such as frequencies in a treble frequency range. As a result, the user perceives a poor frequency response of the earbud, such as a roll-off in the bass and/or sub-bass region. Further, some audio devices featuring active noise cancellation, in which anti-noise is added to the audio output to cancel ambient noise, and audio leakage can reduce the effectiveness of the active noise cancellation. In some cases, leakage of some frequencies of the anti-noise can reduce cancellation of the noise, particularly in the bass or sub-bass frequency range. In other cases, the audio device can adjust the anti-noise to compensate for audio leakage (e.g., increasing the intensity of bass or sub-bass frequencies of the anti-noise), but such compensation can reduce the efficiency of the anti-noise.

As the foregoing illustrates, what is needed are self-sealing ear-tips for in-ear headphones.

### SUMMARY

An embodiment includes an apparatus includes an audio generating element; a sleeve including a longitudinal channel, an outer surface of the sleeve including at least a first portion that is expandable in a cross-sectional size in at least one direction; and a rigid insert configured for insertion into the longitudinal channel. At least the first portion of the outer surface of the sleeve expands in the at least one direction when the rigid insert is inserted into the longitudinal channel.

At least one technical advantage of the disclosed techniques relative to the prior art is that, with the disclosed techniques, an improved fit between an ear tip for an in-ear headphone and the ear canal of the user increases the retention of the assembly, and the assembly is less likely to be dislodged, particularly during physical activity. The ability of the assembly to collapse in a cross-dimensional size in at least one direction improves the comfort and ease of inserting and removing the earbud and enables the user to position each earbud at a desired depth. The adaptability of the cross-dimensional size expansion of the assembly to different shapes improves the ability of the assembly to fit the differently-shaped ear canals of a variety of users. The increased fit reduces audio leakage, thus preserving audio quality and, in some cases, the effectiveness and efficiency of active noise cancellation. As a result, an improved and/or ideal seal in the ear canal of the user is enabled. Thus, the user can better enjoy music and other audio content in full bandwidth. Yet another advantage is that the assembly is durable, reusable, and easy to clean. Yet another advantage is that the manufacturing complexity of the assembly as described herein is low, particularly when compared to the manufacturing of customized ear buds. Yet another advantage is that operation of the assembly as described herein is easy for an average user. That is, no specialized knowledge or training is needed to achieve the improved or ideal seal in the ear canal of the user. These technical advantages provide one or more technological improvements over prior art in-ear headphones.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1A illustrates a self-sealing ear-tip assembly in an unexpanded configuration, according to various embodiments;

FIG. 1B illustrates the self-sealing ear-tip assembly of FIG. 1A in an expanded configuration, according to various embodiments;

FIG. 2 illustrates an insertion of the self-sealing ear-tip assembly of FIG. 1A in the unexpanded configuration within an ear canal of a user, according to various embodiments;

FIG. 3 illustrates the self-sealing ear-tip assembly of FIG. 1B in the expanded configuration within the ear canal of the user, according to various embodiments;

FIG. 4 illustrates a side view of a shape of a first example sleeve of the self-sealing ear-tip assembly of FIGS. 1A-1B, according to various embodiments;

FIG. 5 illustrates an isometric view of the first example sleeve of FIG. 4, according to various embodiments;

FIG. 6 illustrates a side view of a shape of a second example sleeve of the self-sealing ear-tip assembly of FIGS. 1A-1B, according to various embodiments;

FIG. 7 illustrates an isometric a view of the second example sleeve of FIG. 6, according to various embodiments;

FIG. 8A illustrates a side view of an example rigid insert and a third example sleeve of the self-sealing ear-tip assembly of FIGS. 1A-B, according to various embodiments;

FIG. 8B illustrates a side view of the example rigid insert and the third example sleeve of FIG. 8A in unexpanded and expanded configurations, according to various embodiments;

FIG. 9 illustrates a cross-section view of a fourth example sleeve of the self-sealing ear-tip assembly of FIGS. 1A-B, according to various embodiments;

FIG. 10 illustrates a flow diagram of method steps for inserting a self-sealing ear-tip assembly, according to various embodiments; and

FIG. 11 illustrates a flow diagram of method steps for removing a self-sealing ear-tip assembly, according to various embodiments.

### DETAILED DESCRIPTION

In the following description, numerous specific details are set forth to provide a more thorough understanding of the various embodiments. However, the inventive concepts can be practiced without one or more of these specific details.

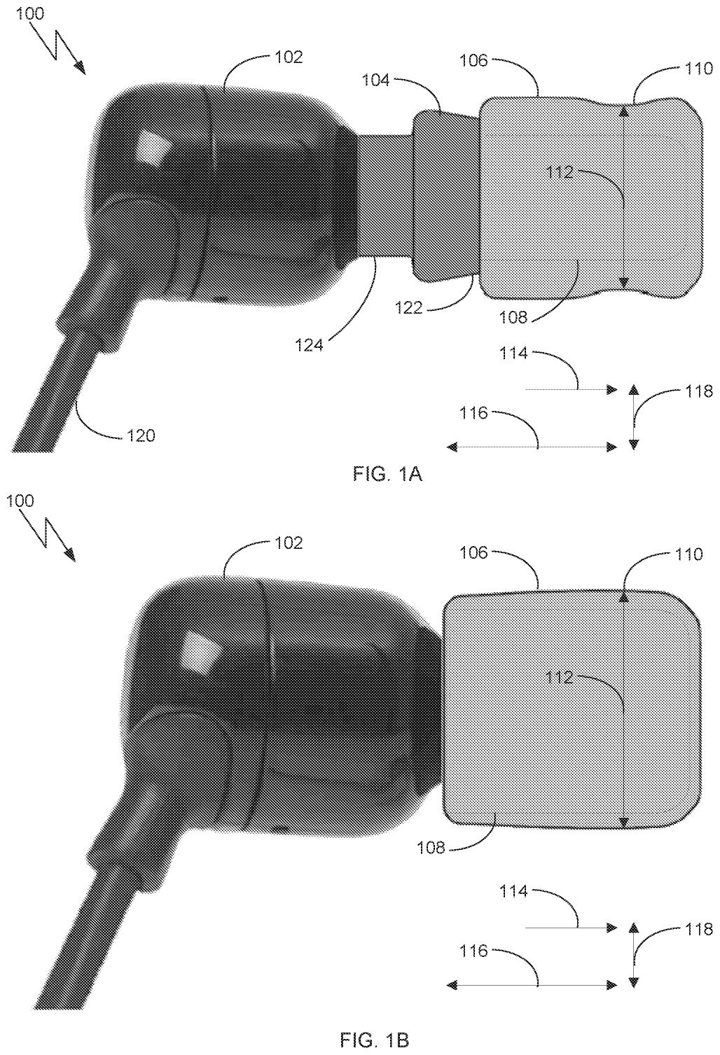

FIG. 1A illustrates a self-sealing ear-tip assembly 100 in an unexpanded configuration, according to various embodiments. The self-sealing ear-tip assembly includes, without limitation, an earbud 102 including a rigid insert 104 and a sleeve 106. Some embodiments include a left earbud 102 for a left ear of a user and a right earbud 102 for a right ear of the user, and the audio generating elements generate stereo and/or positional audio.

The earbud 102 includes an audio generating element (not shown) that is configured to output audio. In some embodiments, a left earbud 102 and a right earbud 102 each include an audio generating element, such as one or more transducers, loudspeakers, or other sound-generating devices (not shown) for emitting sound from the rigid insert 104, through the sleeve 106, and into a corresponding ear canal of a user. In some embodiments, a loudspeaker is disposed in a body portion of a left earbud 102 or a right earbud 102. In some embodiments, such a loudspeaker is disposed at least partially within the rigid insert 104. In some embodiments, the audio generating element receives an audio signal from an audio source, such as a mobile phone. For example (without limitation), the earbud 102 can include a wired connection 120 configured to couple the audio generating element to an audio source. Alternatively or additionally, the earbud 102 can include an audio receiver (not shown) configured to cause the audio generating element to generate audio based on an audio signal received from an audio source. The audio receiver can be a wireless audio receiver that receives the audio signal via radiofrequencies such as AM or FM broadcast, or via digital communications such as WiFi, 5G, Bluetooth, and/or cellular communications. In some embodiments, the self-sealing ear-tip assembly 100 includes a volume control module (not shown) coupled to a left earbud 102 and/or a right earbud 102 (e.g., via the wired connection 120). In some embodiments, the audio source is an anti-noise generator of an active noise cancellation (ANC) system. Some ANC systems include a microphone that detects ambient noise, and, as an audio source, an anti-noise generator that generates an anti-noise that cancels or reduces the ambient noise by destructive interference. In such embodiments, the improved seal and reduced leakage created between the sleeve 106 and an ear canal of the user can improve the effectiveness and/or the efficiency of the ANC system. Alternatively or additionally, in some embodiments, the earbud 102 includes an audio pass-through feature, in which a microphone detects environmental audio, and the speaker reproduces the environmental audio with the audio from the audio source. Such audio pass-through configurations aid the user in hearing environmental audio that is blocked by the seal of the earbud 102.

The sleeve 106 is formed of a flexible material, such as (without limitation) silicone, rubber, neoprene, or the like. In some embodiments, the sleeve 106 is formed of an elastic material that returns to an original shape after being stretched. As shown, the sleeve 106 has an hourglass shape, in which a cross-sectional size in at least one direction at the first portion 110 of the outer surface of the sleeve 106 is smaller than the cross-sectional size in at least one direction of other portions of the outer surface of the sleeve 106. In various embodiments and as discussed in detail below, the sleeve 106 can be formed of other shapes, such as (without limitation) a cylinder, a cone, or the like. The sleeve 106 includes a longitudinal channel 108, such as a longitudinally oriented space with an aperture on an outer surface of the sleeve 106. The longitudinal channel 108 extends within the sleeve 106 along the insertion axis 116 (e.g., the horizontal direction in FIG. 1A). In some embodiments, the longitudinal channel 108 has only one aperture, while in other embodiments, the longitudinal channel 108 passes through the sleeve 106 and connects the aperture to one or more additional apertures on the outer surface of the sleeve 106.

An outer surface of the sleeve 106 includes at least a first portion 110 that is expandable along a cross-sectional size 112 in at least one direction (e.g., expanding along the vertical direction in FIG. 1A). That is, a cross-sectional size 112 of the outer surface of the sleeve 106 expands in at least one direction, such as a radial direction 118. In some embodiments, the first portion 110 of the outer surface of the sleeve 106 stretches outward in response to physical pressure from the rigid insert 104 against an inner surface of the longitudinal channel 108 at the longitudinal position of the first portion 110 within the longitudinal channel 108. In some embodiments (not shown), an entire outer surface of the sleeve 106 is expandable in a cross-sectional size 112 in at least one direction in response to such physical pressure.

The earbud 102 includes a rigid insert 104 that is insertable into an ear canal of a user. More particularly, the rigid insert 104 is designed to be inserted into the sleeve 106 in an insertion direction 114 (e.g., the rightward direction in FIG. 1A) along an insertion axis 116 (e.g., the horizontal direction in FIG. 1A). The earbud 102 has a distal end 122 (e.g., an end that is furthest in the ear canal of the user when the rigid insert 104 inserted into the ear canal). The earbud 102 also has a proximal end 124 (e.g., an end that is closest to an external opening of the ear canal of the user when the rigid insert 104 is inserted into the ear canal). In some embodiments, the rigid insert 104 is formed of a hard, lightweight plastic. As shown, the rigid insert 104 has a cone shape, in which a cross-sectional size in at least one direction of a first portion of an outer surface of the rigid insert 104 that is closer to the proximal end 124 of the rigid insert 104 (e.g., a tail portion) is larger than the cross-sectional size in at least one direction of a second portion that is closer to the distal end 122 of the rigid insert 104. In various embodiments and as discussed in detail below, the rigid insert 104 can be formed of other shapes, such as (without limitation) a cylinder, an hourglass, or the like. Audio from the audio generating element is emitted from the rigid insert. In some embodiments, the audio generating element is fully or partially positioned within the rigid insert 104.

In some embodiments, the parts of the self-sealing ear-tip assembly 100 fit together as a piston-cylinder assembly. The rigid insert 104 is configured for insertion into the longitudinal channel 108 of the sleeve 106. That is, the rigid insert 104 can be inserted into the longitudinal channel 108 in the insertion direction 114, and the sleeve 106 fits around the rigid insert (e.g., the cross-section stretches in a cross-sectional size in at least one direction, such as a radial direction 118, to accommodate the rigid insert 104). In the unexpanded configuration as shown, the rigid insert 104 is not inserted into the sleeve 106 or is only partially inserted into the sleeve, and the cross-sectional size 112 of the first portion 110 of the outer surface of the sleeve 106 is not expanded.

FIG. 1B illustrates the self-sealing ear-tip assembly 100 of FIG. 1A in an expanded configuration, according to various embodiments. The self-sealing ear-tip assembly 100 includes, without limitation, the earbud 102 including the rigid insert 104 and the sleeve 106.

In the expanded configuration as shown, the rigid insert 104 expands a periphery of the sleeve 106 when fully inserted into the longitudinal channel 108 of the sleeve 106. The rigid insert 104 applies pressure against an inner surface of the longitudinal channel 108. As shown, the tail portion of the rigid insert 104 has a larger cross-sectional size in at least one direction than an inner surface of the longitudinal channel 108 at the position of the first portion 110. As a result, the full insertion of the rigid insert 104 into the longitudinal channel 108 causes the cross-sectional size 112 of the first portion 110 of the outer surface of the sleeve 106 to expand in at least one direction. As shown, the expanding of the cross-sectional size 112 in at least one direction causes the shape of the outer surface of the sleeve 106 to change from an hourglass shape to a cylinder or barrel shape.

In some embodiments, the shape of the outer surface of the sleeve 106 can vary, enabling the sleeve to fit the shape of an ear canal of a particular user. For example, a first user whose ear canals are approximately cylindrical can expand the sleeve 106 to a first extent in which the outer surface of the sleeve 106 is cylindrical. A second user whose ear canals are more oval-shaped can expand the sleeve 106 to a second extent in which the outer surface of the sleeve 106 is also oval-shaped. A third user whose ear canals are asymmetrical can expand the sleeve 106 to a third extent in which the outer surface of the sleeve 106 is also asymmetrical. As a result, different users can change the shape of the sleeve 106 to provide an improved seal in the ear canal.

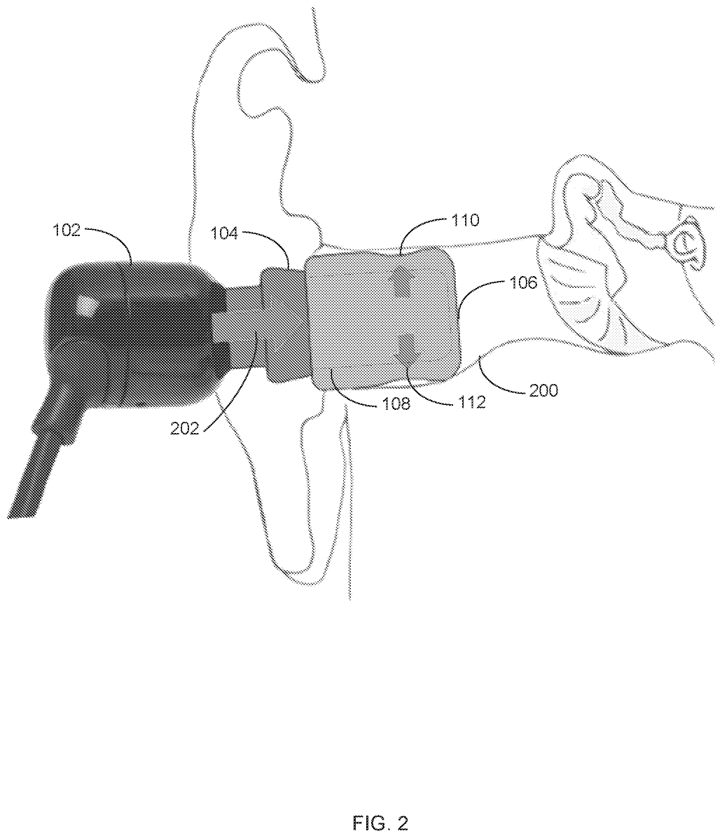

FIG. 2 illustrates an insertion of the self-sealing ear-tip assembly 100 of FIG. 1A in the unexpanded configuration within an ear canal 200 of a user, according to various embodiments. The self-sealing ear-tip assembly 100 includes, without limitation, the earbud 102 including the rigid insert 104 and the sleeve 106.

As shown, the sleeve 106 is inserted into an ear canal 200 of a user. As shown, the self-sealing ear-tip assembly is in the closed configuration, in which the sleeve 106 is inserted into the ear canal 200 and the rigid insert 104 is partially, but not fully, inserted into the sleeve 106. In the closed configuration, the cross-sectional size 112 of the first portion 110 of the outer surface of the sleeve 106 is unexpanded, which enables the user to position the sleeve 106 at a desired location in the ear canal (e.g., a desired insertion depth and/or insertion orientation). When the user has positioned the sleeve 106 at the desired location, the user can press the earbud 102 in an insertion direction 202 to insert the rigid insert 104 further into the longitudinal channel 108 of the sleeve 106.

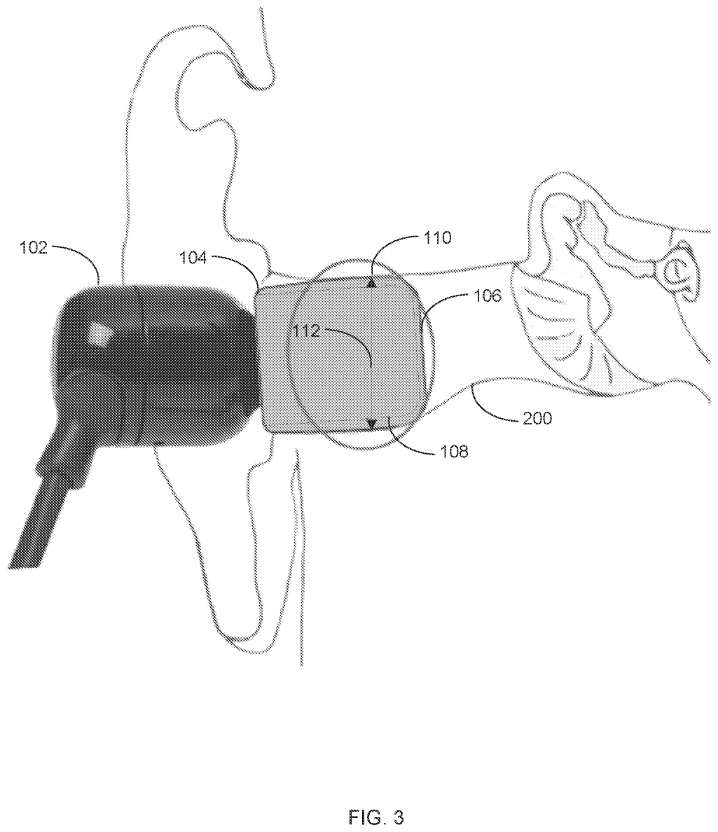

FIG. 3 illustrates the self-sealing ear-tip assembly 100 of FIG. 1B in the expanded configuration within the ear canal 200 of the user, according to various embodiments. The self-sealing ear-tip assembly 100 includes, without limitation, the earbud 102 including the rigid insert 104 and the sleeve 106.

As shown, the self-sealing ear-tip assembly is in the expanded configuration, in which the sleeve 106 is inserted into the ear canal 200 and the rigid insert 104 is fully inserted into the sleeve 106. The rigid insert 104 has a cone shape, in which a cross-sectional size of a portion of the rigid insert 104 toward the proximal end 124 in at least one direction is larger than the cross-sectional size in the at least one direction of an inner surface of the longitudinal channel 108 at the position of the first portion 110. As a result, inserting the rigid insert 104 causes the cross-sectional size 112 of the first portion 110 of the outer surface of the sleeve 106 to expand in the at least one direction. As shown, the expanding of the cross-sectional size 112 in the at least one direction causes the shape of the outer surface of the sleeve 106 to change from an hourglass shape to a cylinder or barrel shape. The expanded cross-sectional size causes the assembly to fill the ear canal 200 of the user, and the outer surface of the sleeve 106 presses against the inner surface of the ear canal 200 to form a seal. In some embodiments, the flexible material of the sleeve 106 causes the outer surface of the sleeve 106 to conform to a shape of the inner surface of the ear canal 200 of the user. The expanding of the cross-sectional size 112 in the at least one direction causes or increases pressure of the outer surface of the sleeve 106 against the ear canal 200 of the user, which creates better friction and/or grip. As a result, air gaps and other seal imperfections between surfaces of the ear canal 200 and the sleeve 106 are reduced or eliminated, creating an improved seal. The improved seal promotes retention of the position of the sleeve 106 and the rigid insert 104 within the ear canal 200 of the user, reduces audio leakage from the audio generating element, and/or reduces ambient noise, among other advantages.

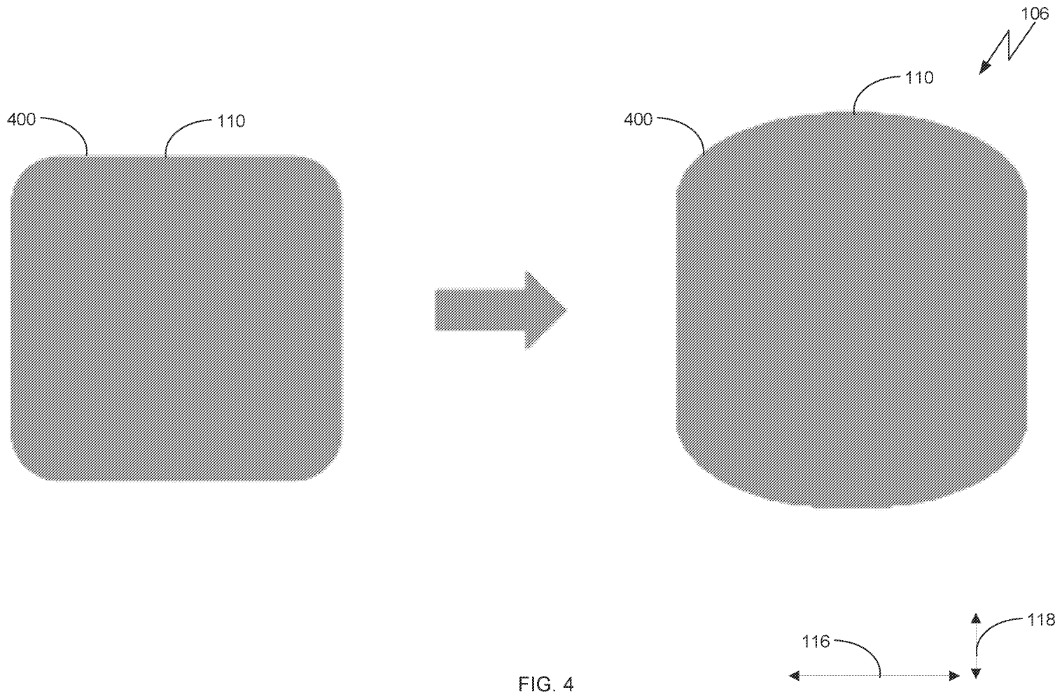

FIG. 4 illustrates a side view of a shape of a first example sleeve of the self-sealing ear-tip assembly of FIGS. 1A-1B, according to various embodiments. The first example sleeve 106 includes, without limitation, an outer surface 400 in which at least a first portion 110 that is expandable in a cross-sectional size in at least one direction (e.g., expanding along the radial direction 118 in FIG. 4).

As shown on the left, in an unexpanded configuration, the first example sleeve 106 has a cylindrical shape. That is, when the rigid insert 104 is not fully inserted into the longitudinal channel 108, the outer surface 400 of the sleeve 106 has a cylindrical shape in which the first portion 110 of the outer surface 400 has a same or similar cross-sectional size in the at least one direction as other portions of the outer surface 400 along the insertion axis 116. As shown on the right, in an expanded configuration, the cross-sectional size of the first portion 110 of the first example sleeve 106 expands in cross-sectional size in the at least one direction (e.g., the radial direction 118), changing the shape of the first example sleeve 106 from a cylindrical shape to a barrel shape. That is, when the rigid insert 104 (not shown) is fully inserted into the longitudinal channel 108 (not shown), the cross-sectional size of the first portion 110 of the outer surface 400 of the sleeve 106 in the at least one direction is larger than the radius of the cylinder. As shown, the sleeve 106 expands circumferentially up to about 30% when the rigid insert 104 (not shown) is fully inserted and the self-sealing ear-tip assembly 100 is in the expanded configuration. In other embodiments, such circumferential expansion can be greater than or less than 30%, depending on various factors, including the material properties of the sleeve 106, the size of the sleeve 106 (in some embodiments, larger sizes have greater circumferential expansion in the expanded configuration), a shape of the ear canal 200, and/or the like.

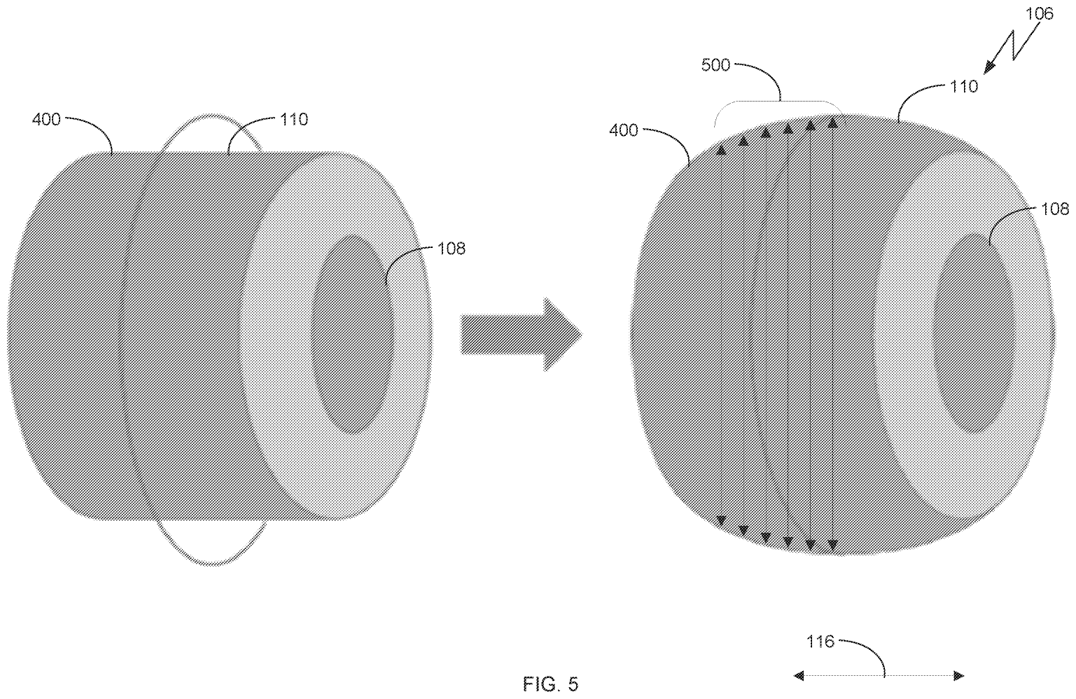

FIG. 5 illustrates an isometric view of the first example sleeve of FIG. 4, according to various embodiments. The first example sleeve 106 includes, without limitation, a longitudinal channel 108 and an outer surface 400 in which at least a first portion 110 that expands as shown via arrows 500 in a cross-sectional size in at least one direction.

As shown on the left, in an unexpanded configuration, the first example sleeve 106 has a cylindrical shape. That is, when the rigid insert 104 is not fully inserted into the longitudinal channel 108, the outer surface 400 of the sleeve 106 has a cylindrical shape, in which the first portion 110 of the outer surface 400 has a same or similar cross-sectional size in the at least one direction as other portions of the outer surface 400 along the insertion axis 116. As shown on the right, in an expanded configuration, the cross-sectional size in the at least one direction of the first portion 110 of the first example sleeve 106 expands as shown via arrows 500, changing the shape of the first example sleeve 106 from a cylindrical shape to a barrel shape. That is, when the rigid insert 104 (not shown) is fully inserted into the longitudinal channel 108, the cross-sectional size in at least one direction of the first portion 110 of the outer surface 400 of the sleeve 106 is larger than the cylindrical radius. As shown, the sleeve 106 expands circumferentially up to about 30% when the rigid insert 104 (not shown) is fully inserted and the self-sealing ear-tip assembly 100 is in the expanded configuration. In other embodiments, such circumferential expansion can be greater than or less than 30%, depending on various factors, including the material properties of the sleeve 106, the size of the sleeve 106 (in some embodiments, larger sizes have greater circumferential expansion in the expanded configuration), a shape of the ear canal 200, and/or the like.

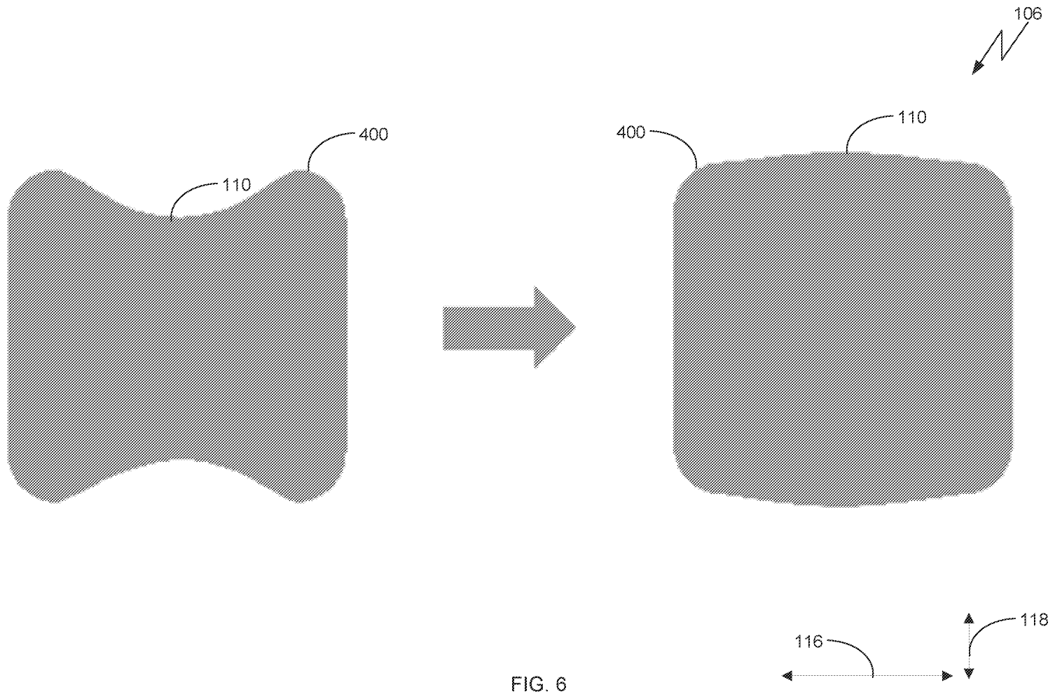

FIG. 6 illustrates a side view of a shape of a second example sleeve 106 of the self-sealing ear-tip assembly of FIGS. 1A-1B, according to various embodiments. The second example sleeve 106 includes, without limitation, an outer surface 400 in which at least a first portion 110 of the sleeve 106 is expandable in a cross-sectional size in at least one direction (e.g., expanding along the radial direction 118 in FIG. 6).

As shown on the left, in an unexpanded configuration, the first example sleeve 106 has a concave cylinder or hourglass shape. That is, when the rigid insert 104 is not fully inserted into the longitudinal channel 108, a first portion 110 of the outer surface 400 has a smaller cross-sectional size in the at least one direction than other portions of the outer surface 400 along the insertion axis 116. As shown on the right, in an expanded configuration, the cross-sectional size in the at least one direction of the first portion 110 of the first example sleeve 106 expands in a cross-sectional size in the at least one direction, changing the shape of the first example sleeve 106 from an hourglass shape to a barrel shape. That is, when the rigid insert 104 (not shown) is fully inserted into the longitudinal channel 108 (not shown), the cross-sectional size of the first portion 110 of the outer surface 400 of the sleeve 106 is larger than the cylindrical radius. As shown, the sleeve 106 expands circumferentially up to about 30% when the rigid insert 104 (not shown) is fully inserted and the self-sealing ear-tip assembly 100 is in the expanded configuration. In other embodiments, such circumferential expansion can be greater than or less than 30%, depending on various factors, including the material properties of the sleeve 106, the size of the sleeve 106 (in some embodiments, larger sizes have greater circumferential expansion in the expanded configuration), a shape of the ear canal 200, and/or the like.

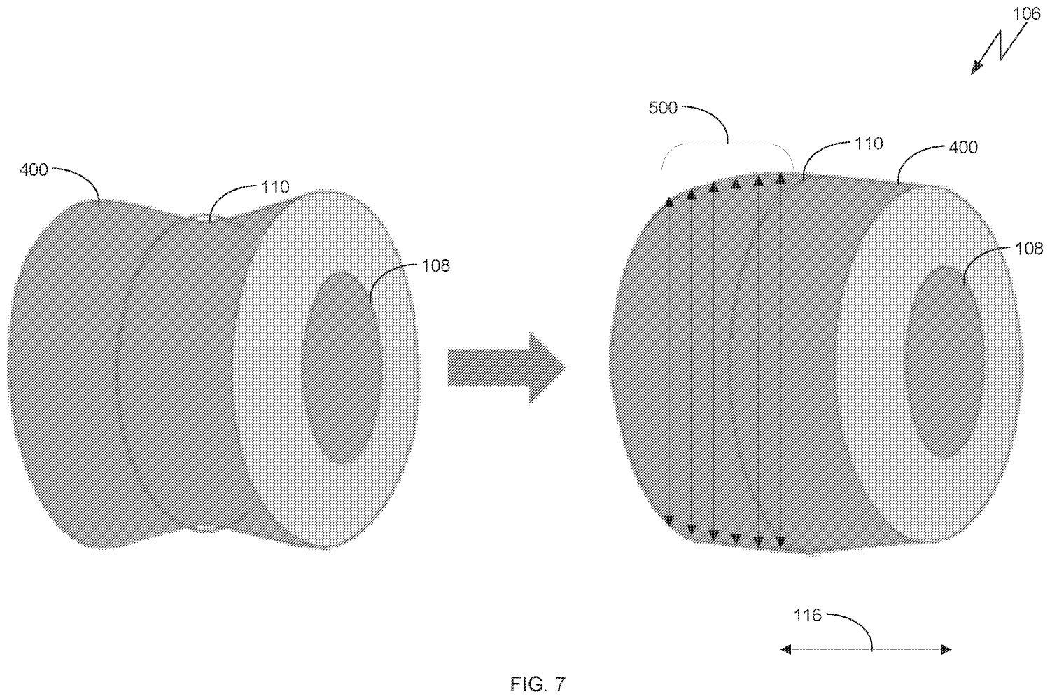

FIG. 7 illustrates an isometric view of the second example sleeve 106 of FIG. 6, according to various embodiments. The second example sleeve 106 includes, without limitation, an outer surface 400 in which at least a first portion 110 that expands in a cross-sectional direction in the at least one size, as shown via arrows 500.

As shown on the left, in an unexpanded configuration, the first example sleeve 106 has a concave cylinder or hourglass shape. That is, when the rigid insert 104 is not fully inserted into the longitudinal channel 108, a first portion 110 of the outer surface 400 has a smaller cross-sectional size in the at least one direction than a second portions of the outer surface 400 along the insertion axis 116. As shown on the right, in an expanded configuration, the cross-sectional size of the first portion 110 of the first example sleeve 106 expands as shown via arrows 500, changing the shape of the first example sleeve 106 from an hourglass shape to a barrel shape. That is, when the rigid insert 104 (not shown) is fully inserted into the longitudinal channel 108, the cross-sectional size in the at least one direction of the first portion 110 of the outer surface 400 of the sleeve 106 is larger than the cylindrical radius. As shown, the sleeve 106 expands circumferentially up to about 30% when the rigid insert 104 (not shown) is fully inserted and the self-sealing ear-tip assembly 100 is in the expanded configuration. In other embodiments, such circumferential expansion can be greater than or less than 30%, depending on various factors, including the material properties of the sleeve 106, the size of the sleeve 106 (in some embodiments, larger sizes have greater circumferential expansion in the expanded configuration), a shape of the ear canal 200, and/or the like.

The shapes shown in FIGS. 4-7 are representative and are not drawn to scale. For example, the expansion in the cross-sectional size depicted in each of FIGS. 4-7 is exaggerated relative to the expansion of the cross-sectional size that occurs in some embodiments in practice for the purpose of illustration.

In various embodiments, a self-sealing ear-tip assembly 100, such as a sleeve 106 thereof, is configured in different shapes, sizes, and/or materials. Some such shapes, sizes, and/or materials enable a user to adapt the self-sealing ear-tip assembly 100 to fit an ear canal 200 of the user. As a first such example (without limitation), a first sleeve 106 of a first shape or size can comfortably fit the ear canal 200 of a first user, and a second sleeve 106 of a different shape or size of a sleeve 106 can comfortably fit the ear canal 200 of a second user. As a first such example (without limitation), a first sleeve 106 made of a first material can be well-suited to a first user (e.g., a latex sleeve that is slightly tacky or high-friction and that provides improved retention for a high-activity first user), and a second sleeve 106 made of a second material can be well-suited to a second user (e.g., a silicone sleeve that is more suitable for a second user who has a latex allergy). Alternatively or additionally, a shape, size, and/or material of the self-sealing ear-tip assembly 100, such as a sleeve 106 and/or rigid insert 104, thereof, can create additional features of the self-sealing ear-tip assembly 100. In some embodiments, a sleeve 106 has a length of approximately 5 millimeters. In some embodiments, a sleeve 106 expands in a cross-sectional size in at least one direction by 1-2 millimeters.

In some embodiments, the rigid insert 104 has a larger maximum cross-sectional size in the at least one direction than an inner surface of a longitudinal channel 108 of a sleeve 106. That is, the cross-sectional size in the at least one direction of at least a first portion of an outer surface of the rigid insert 104 is larger than the cross-sectional size in the at least one direction of a first portion of an inner surface of the longitudinal channel 108. As a result, inserting at least the first portion of the rigid insert 104 into the sleeve 106 causes the sleeve 106 to expand in cross-sectional size in the at least one direction. Further, in some embodiments, only a portion of the rigid insert 104 has a larger cross-sectional size in the at least one direction than the inner surface of the longitudinal channel 108 (e.g., a barrel shape, or a concave cylinder or hourglass shape). That is, a cross-sectional size in the at least one direction of a second portion of the outer surface of the rigid insert 104 is smaller than the cross-sectional size in the at least one direction of the first portion of the outer surface of the rigid insert 104. In some such embodiments, including the embodiment shown in FIGS. 1A and 1B, the first portion of the outer surface with a larger cross-sectional size in at least one direction is closer to the distal end 122 of the rigid insert 104 than a second portion. That is, the first portion of the outer surface of the rigid insert (e.g., having the larger cross-sectional size in the at least one direction) is closer to the distal end 122 of the rigid insert 104 than the second portion of the outer surface of the rigid insert 104. Further, in some embodiments, the sleeve 106 can have a complementary shape. That is, a cross-sectional size in the at least one direction of the first portion of the inner surface of the longitudinal channel 108 can be smaller than the cross-sectional size in the at least one direction of the first portion of the outer surface of the rigid insert 104. Also, the first portion of the outer surface of the rigid insert 104 can be closer to the distal end 122 of the rigid insert 104 than the first portion of the inner surface of the longitudinal channel 108 when the rigid insert 104 is fully inserted into the longitudinal channel 108. In such embodiments, a backward-facing surface of the first portion of the rigid insert 104 and a forward-facing surface of the first portion of the inner surface of the longitudinal channel 108 can form a backstop. The backstop can help hold the rigid insert 104 into the sleeve 106 when fully inserted, and/or can create a tactile and/or audible “click” sound to indicate that the rigid insert 104 is fully inserted into the sleeve 106.

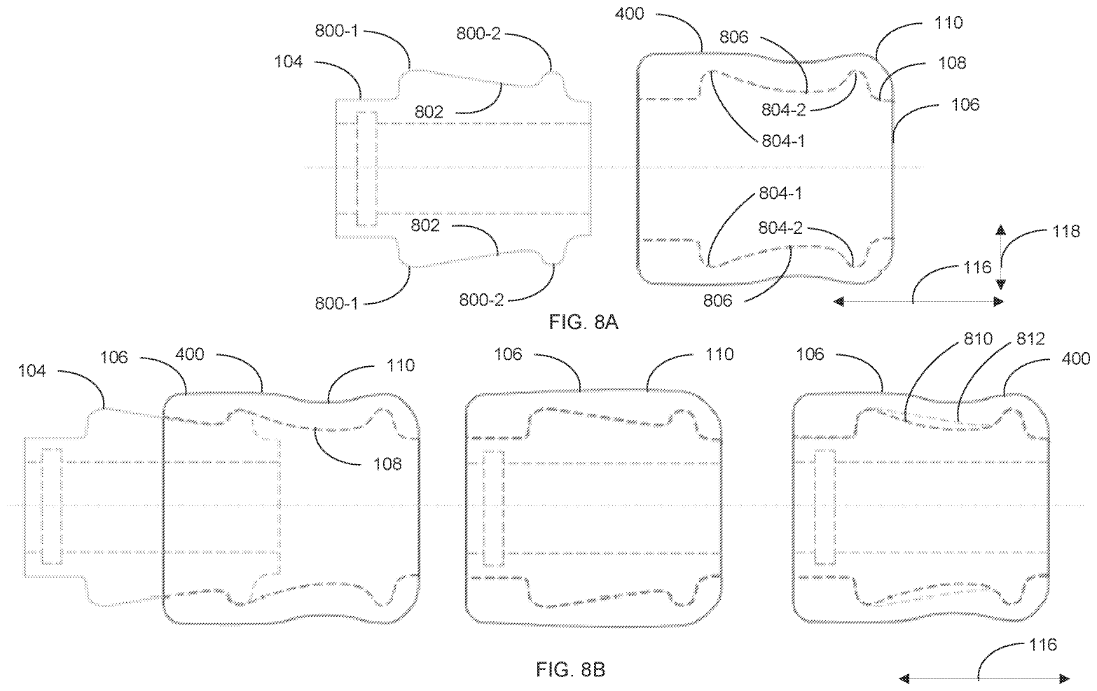

FIG. 8A illustrates a side view of an example rigid insert 104 and a third example sleeve 106 of the self-sealing ear-tip assembly 100 of FIGS. 1A-B, according to various embodiments. The third example sleeve 106 includes, without limitation, an outer surface 400 having a first portion 110 and a longitudinal channel 108.

As shown, an outer surface of the example rigid insert 104 has a first portion 800-1 and a second portion 800-2 that are of larger diameter than other portions of the rigid insert 104. That is, a first portion 800-1 and a second portion 800-2 of an outer surface of the rigid insert 104 are located at different positions along an insertion axis 116 of the rigid insert 104. The second portion 800-2 of the outer surface of the rigid insert 104 has a cross-sectional size in at least one direction that is at least as large as the cross-sectional size in the at least one direction of the first portion 800-1 of the outer surface of the rigid insert 104. In some embodiments, the cross-sectional size in the at least one direction of the first portion 800-1 of the outer surface of the rigid insert 104 is larger than the cross-sectional size in the at least one direction of the second portion 800-2 of the outer surface of the rigid insert 104, or vice versa. Further, in some embodiments, the portion of the outer surface of the rigid insert 104 between the first portion 800-1 and second portions 800-2 is concave. That is, in some embodiments, the rigid insert 104 has a third portion 802 of the outer surface that is between the first portion 800-1 of the outer surface and the second portion 800-2 of the outer surface along the insertion axis 116. Further, the cross-sectional size in the at least one direction of the third portion 802 can be smaller than the cross-sectional size in the at least one direction of the first portion 800-1 and the second portion 800-2 of the outer surface of the rigid insert 104. In various embodiments, the first portion 800-1 and/or second portion 800-2 of the outer surface of the rigid insert 104 can be bumps, ridges, or the like. In various embodiments, the rigid insert 104 can have three or more portions of larger cross-sectional sizes in the at least one direction than the other portions of the outer surface of the rigid insert 104.

As shown, the third example sleeve 106 has a longitudinal channel 108 in which an inner surface has one or more notches, that is, portions that are expanded in a cross-sectional size in the at least one direction to correspond to the larger cross-sectional size portions of the rigid insert 104. That is, a cross-sectional size in the at least one direction of a first portion 804-1 of an inner surface of the longitudinal channel 108 can be larger than a third portion 806 of the inner surface of the longitudinal channel 108. Also, a cross-sectional size in the at least one direction of a second portion 804-2 of the inner surface of the longitudinal channel 108 can be at least as large as the cross-sectional size in the at least one direction of the first portion 800-1 of the outer surface of the rigid insert 104. As shown, the third example sleeve 106 has a longitudinal channel 108 with a first portion 804-1 in which a cross-sectional size in the at least one direction is expanded, and a second portion 804-2 in which the cross-sectional size in the at least one direction is expanded, which respectively correspond to the first portion 800-1 and second portion 800-2 of the outer surface of the rigid insert 104. That is, in some embodiments, a first portion 804-1 and a second portion 802-2 of the inner surface of the longitudinal channel 108 are located at different positions along the insertion axis 116 of the longitudinal channel 108. Further, the first portion 804-1 and the second portion 802-2 of the inner surface of the longitudinal channel 108 have a cross-sectional size in the at least one direction that is at least as large as the cross-sectional size in at least one direction of the first and seconds portions of the outer surface of the rigid insert 104.

FIG. 8B illustrates a side view of the example rigid insert 104 and the third example sleeve 106 and of FIG. 8A in unexpanded and expanded configurations, according to various embodiments. The third example sleeve 106 includes, without limitation, an outer surface 400 having a first portion 110 and a longitudinal channel 108.

As shown on the left, in an unexpanded configuration, the rigid insert 104 is partially inserted into the sleeve 106. The cross-sectional size in the at least one direction of the first portion 110 of the outer surface 400 of the sleeve 106 remains in an unexpanded configuration, allowing the user to position the sleeve 106 within the ear canal 200. Further, a second portion 800-2 of the outer surface of the rigid insert 104 with a larger cross-sectional size in the at least one direction is at a corresponding position along an insertion axis 116 as a first portion 804-1 (e.g., a first notch) of the inner surface of the longitudinal channel 108. That is, when the rigid insert 104 is partially inserted into the longitudinal channel 108, a position of the second portion 800-2 of the outer surface of the rigid insert 104 along the insertion axis 116 corresponds to a position of the first portion 804-1 of the inner surface of the longitudinal channel 108 along the insertion axis. As a result, the rigid insert 104 is retained within the sleeve 106 in the unexpanded configuration. Further, during withdrawal of the assembly from the ear canal 200 (e.g., due to the user pulling the earbud 102 outward from the ear canal 200), the first portion 800-1 of the outer surface of the rigid insert 104 pulls the sleeve 106, aiding the user in withdrawing the sleeve 106 from the ear canal 200. In some embodiments, a first portion of the sleeve 106 (e.g., the first portion 804-1 of the inner surface of the longitudinal channel 108) is less elastic than a second portion of the sleeve 106 (e.g., the second portion 804-2 of the inner surface of the longitudinal channel 108).

As shown in the center, in an expanded configuration, the rigid insert 104 is fully inserted into the sleeve 106. The user can fully insert the rigid insert 104 into the sleeve 106, for example, by pushing the rigid insert 104 into the ear canal 200. Alternatively, the user can fully insert the rigid insert 104 into the sleeve 106 by pulling on the sleeve 106 while holding the rigid insert 104. In either case, the cross-sectional size of the first portion 110 of the outer surface 400 of the sleeve 106 is expanded in the at least one direction, improving a seal of the sleeve 106 within the ear canal 200. Further, the first portion 800-1 of the outer surface of the rigid insert 104 with a larger cross-sectional size is at a corresponding position along the insertion axis 116 as the first notch of an inner surface of the longitudinal channel 108. That is, when the rigid insert 104 is fully inserted into the longitudinal channel 108, a position of the first portion 800-1 of the outer surface of the rigid insert 104 along the insertion axis 116 corresponds to a position of the first portion 804-1 of the inner surface of the longitudinal channel 108 along the insertion axis 116. Similarly, the second portion 800-2 of the outer surface of the rigid insert 104 with a larger cross-sectional size is at a corresponding position along the insertion axis 116 as the second notch of the inner surface of the longitudinal channel 108. That is, when the rigid insert 104 is fully inserted into the longitudinal channel 108, a position of the second portion 800-2 of the outer surface of the rigid insert 104 along the insertion axis 116 corresponds to a position of the second portion 804-2 of the inner surface of the longitudinal channel 108 along the insertion axis 116. As a result, the rigid insert 104 is retained within the sleeve 106 in the expanded configuration.

In some embodiments, when the rigid insert 104 is partially inserted into the longitudinal channel, the configuration in which the second portion 800-2 of the outer surface 400 of the rigid insert 104 corresponds to a position of the first portion 804-1 of the inner surface of the longitudinal channel along the insertion axis to expand the first portion 110 of the sleeve 106 to a first cross-sectional size in the at least one direction. Expanding the first portion 110 of the sleeve 106 to the first cross-sectional size when the apparatus is inserted into an ear canal 200 of a user can create a first seal within the ear canal 200 of the user. Further, when the rigid insert 104 is further inserted into the longitudinal channel 108, a position of the first portion 800-1 of the outer surface of the rigid insert 104 along the insertion axis corresponds to the position of the first portion 804-1 of the inner surface of the longitudinal channel along the insertion axis 116. This correspondence causes the first portion 110 of the outer surface of the sleeve 106 to expand to a second cross-sectional size in the at least one direction. Expanding the first portion 110 of the sleeve 106 to the second cross-sectional size when the apparatus is inserted into the ear canal 200 of the user can create a second seal within the ear canal 200 of the user, which can be tighter than the first seal, or vice versa. The second notch holds the second portion of the outer surface of the rigid insert 104 in the unexpanded configuration until a user exerts sufficient outward force (e.g., away from the ear canal 200) on an earbud 102 (not shown) to move the second portion of the outer surface of the rigid insert 104 out of the second notch and into the first notch. In some embodiments, the self-sealing ear-tip assembly 100 can be removed from the ear canal 200 before the rigid insert 104 is moved from the unexpanded configuration to the expanded configuration.

As shown on the right, in some embodiments, the notches of the longitudinal channel 108 allow the self-sealing ear-tip assembly 100 to be held in the unexpanded configuration, due to the circumferential or peripheral ridge of the rigid insert 104 being positioned in the second notch. This figure shows a difference in profile between a third portion 810 of the inner surface of the longitudinal channel 108 and a third portion 812 of the outer surface of the rigid insert 104. As shown, the third portion 812 of the outer surface of the rigid insert 104 has a larger cross-sectional size in the at least one direction than the third portion 810 of the inner surface of the longitudinal channel 108. That is, a cross-sectional size in the at least one direction of the third portion 810 of the outer surface of the rigid insert 104 is larger than a cross-sectional size in the at least one direction of a third portion 812 of the inner surface of the longitudinal channel 108, and a position of the third portion 810 of the outer surface of the rigid insert 104 corresponds to the third portion 812 of the inner surface of the longitudinal channel 108 when the rigid insert 104 is inserted into the longitudinal channel 108. As shown, when a position of the second portion 800-2 of the outer surface of the rigid insert 104 corresponds to a position of the second portion of the inner surface of the longitudinal channel 108, the third portion 810 of the inner surface of the longitudinal channel 108 resists withdrawal of the rigid insert 104 from the sleeve 106. Further, as shown, when the rigid insert 104 is inserted into the longitudinal channel 108, the third portion 812 of the inner surface of the longitudinal channel 108 creates pressure against the third portion 810 of the outer surface of the rigid insert 104. The pressure secures the rigid insert 104 within the longitudinal channel 108.

As further shown, an outer surface of the rigid insert 104 can include one or more tapered portions. That is, a cross-sectional size in the at least one direction of a tapered portion of the outer surface of the rigid insert 104 can monotonically increase along an insertion axis 116 of the rigid insert 104. For example (without limitation), a portion of the outer surface of the rigid insert 104 can taper with a decreasing cross-sectional size in the at least one direction toward the distal end 122. That is, the tapered portion can be closer to the distal end 122 of the rigid insert 104 than the first portion 110 of the outer surface of the rigid insert 104, and the cross-sectional size in the at least one direction of the tapered portion can monotonically decrease along the insertion axis 116 in the insertion direction 114. In such embodiments, the tapering can cause gradual insertion of the rigid insert 104 into the sleeve 106, resulting in a more comfortable insertion. Alternatively or additionally, a portion of the outer surface of the rigid insert 104 can taper with an increasing cross-sectional size in the at least one direction toward the distal end 122 of the rigid insert 104. That is, the first portion of the outer surface of the rigid insert 104 can be closer to the distal end 122 of the rigid insert 104 than the tapered portion, and the cross-sectional size in the at least one direction of the tapered portion can monotonically increase along the insertion axis 116 in the insertion direction 114. In such embodiments, the tapering can cause gradual removal of the rigid insert 104 from the sleeve 106, resulting in a more comfortable withdrawal.

In some embodiments, in addition to an outer surface of the rigid insert 104 having two or more portions of larger cross-sectional sizes in the at least one direction, the shapes and/or sizes of the portions can vary. For example, a cross-sectional size in the at least one direction of a first portion can be larger than a cross-sectional size in the at least one direction of a second portion. In such embodiments, at a first insertion depth, the second portion fits within the notch of the longitudinal channel 108 to create a seal with a first cross-sectional size and a first level of pressure. That is, when the rigid insert 104 is inserted into the longitudinal channel 108, a position of the second portion of the outer surface of the rigid insert 104 along the insertion axis 116 corresponds to the position of the first portion of the inner surface of the longitudinal channel 108 along the insertion axis 116. At a second insertion depth, the first portion fits within the notch at the first portion 110 of the longitudinal channel 108 to create a seal with a second, larger cross-sectional size and a second, greater level of pressure. That is, when the rigid insert 104 is inserted into the longitudinal channel 108, a position of the second portion of the outer surface of the rigid insert 104 along the insertion axis 116 corresponds to the position of the first portion of the inner surface of the longitudinal channel 108 along the insertion axis 116. As a result, the user can choose or adjust the seal between different levels of pressure and/or to fit the ear canal 200 of the user.

In some embodiments, in addition to an inner surface of the longitudinal channel 108 having two or more notches that respectively fit a portion of the outer surface of the rigid insert 104, the shapes and/or sizes of the notches can vary. For example and without limitation, a first notch can be taller or deeper than the second notch, and therefore causes less expanding of the outer portion of the sleeve in a cross-sectional size in the at least one direction. In such embodiments, at a first insertion depth, a portion of the outer surface of the rigid insert 104 fits within a first notch of the longitudinal channel 108. That is, when the rigid insert 104 is inserted into the longitudinal channel 108, a position of a portion of the outer surface of the rigid insert 104 along the insertion axis 116 corresponds to the position of a first portion of the inner surface of the longitudinal channel 108 along the insertion axis 116. At the first insertion depth, the cross-sectional size of the outer surface of the sleeve 106 expands in the at least one direction (e.g., by 1.0 millimeter) to create a seal with a first level of pressure. At a second insertion depth, a portion of the outer surface fits within a second notch at the first portion 110 of the longitudinal channel 108. That is, when the rigid insert 104 is inserted into the longitudinal channel 108, the position of the first portion of the outer surface of the rigid insert 104 along the insertion axis 116 corresponds to the position of a second portion of the inner surface of the longitudinal channel 108 along the insertion axis 116. At the second insertion depth, the cross-sectional size of the outer surface of the sleeve 106 expands in the at least one direction (e.g., by 2.0 millimeters) to create a seal with a second level of pressure. As a result, the user can choose or adjust the seal between different levels of pressure and/or to fit the ear canal 200 of the user. Some embodiments include two or more portions of larger cross-sectional sizes, and optionally of different cross-sectional sizes and/or shapes, and/or two or more notches of different sizes and/or shapes.

In some embodiments, shapes, sizes, and/or features of the rigid insert 104 and the sleeve 106 can aid in an alignment of the rigid insert with the sleeve 106, e.g., securing the rigid insert 104 in a rotational orientation with respect to the sleeve 106. For example (without limitation), the alignment can be chosen to orient and hold a wired connection 120 of an earbud 102 in a downward direction (e.g., toward an audio source that is below the ear canal 200 of the user).

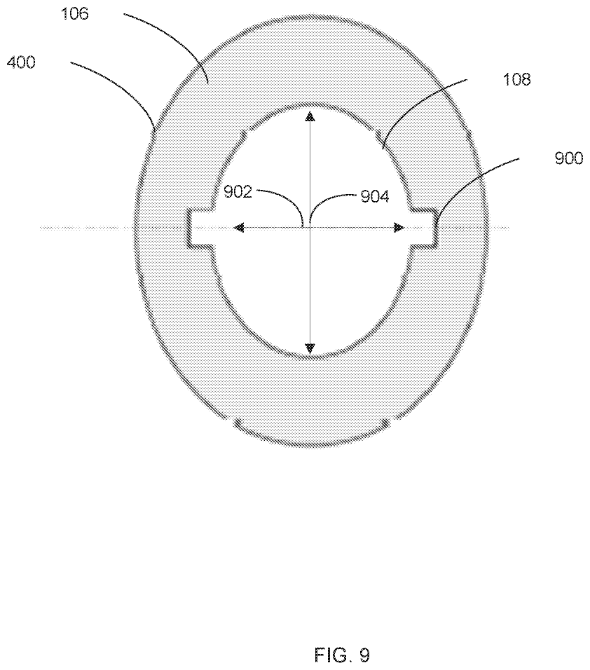

FIG. 9 illustrates a cross-section view of a fourth example sleeve 106 of the self-sealing ear-tip assembly of FIGS. 1A-B, according to various embodiments. The fourth example sleeve 106 includes, without limitation, a longitudinal channel 108 and an outer surface 400.

As shown, the fourth example sleeve 106 has an oval shape. As a first example (without limitation), the outer surface of the sleeve 106 can have an oval shape. That is, in some embodiments, at least a portion of the outer surface of the sleeve 106 has a different cross-sectional size in a first direction 902 than in a second direction 904. A sleeve with an oval shape can result in a better fit and improved seal for users with a non-circular ear canal 200. Further, in such embodiments, a better seal can be achieved, because less expansion of the periphery of the sleeve 106 can be needed to form a seal with the ear canal 200. Further, in such embodiments, the rigid insert 104 can remain comfortable for the user while inserted in the ear canal 200 for a longer period of comfort.

As a second example (without limitation), the inner surface of the longitudinal channel 108 can have an oval shape. That is, in some embodiments, at least a portion of the inner surface of the longitudinal channel 108 has a different cross-sectional size in a first cross-sectional direction than in a second cross-sectional direction. Further, an outer surface of a rigid insert (not shown) can have a different cross-sectional size in the first cross-sectional size in at least one direction than in the second cross-sectional size in at least direction. As a result of the different radii of the longitudinal channel 108 and the rigid insert, inserting the rigid insert in an orientation in which the radii correspond can secure a rotational orientation of the rigid insert within the longitudinal channel 108.

As shown, the fourth example sleeve 106 has a longitudinal channel 108 including an alignment element (e.g., a pair of notches 900 formed in the inner surface of the longitudinal channel 108). Further, an outer surface of a rigid insert (not shown) can have a second alignment element configured to couple with the first alignment element when the rigid insert 104 is inserted into the longitudinal channel 108 (e.g., a pair of nubs, each configured to couple with one of the notches 900). Inserting the rigid insert in an orientation in which the nubs of the rigid insert 104 couple with the notches 900 of the longitudinal channel 108 can secure a rotational orientation of the rigid insert within the longitudinal channel 108.

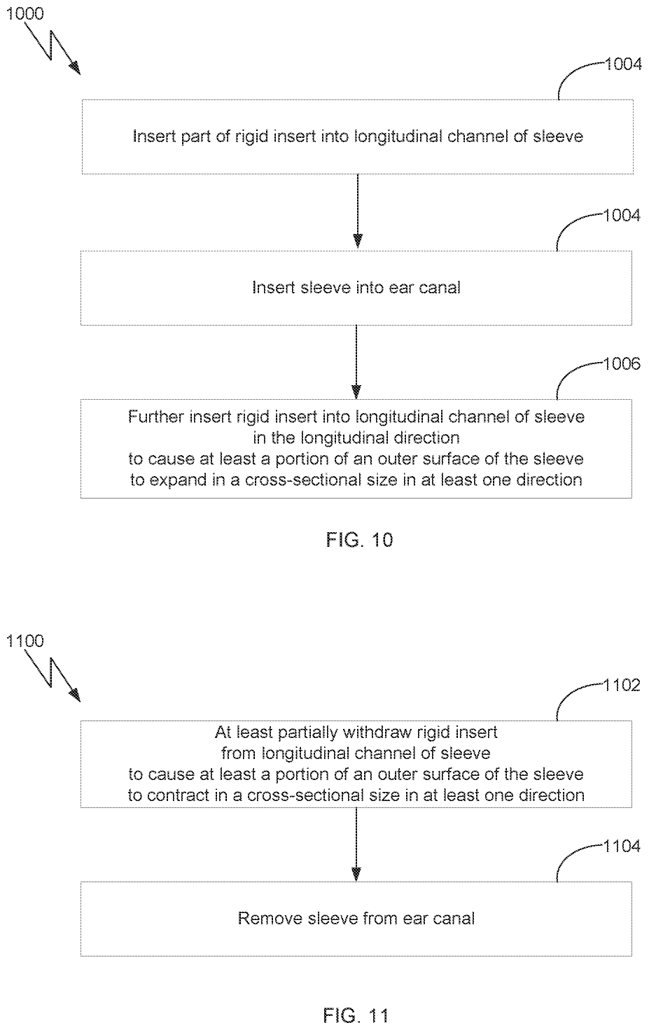

FIG. 10 illustrates a flow diagram of method steps for inserting a self-sealing ear-tip assembly 100, according to various embodiments. The method steps of FIG. 10 can be applied, e.g., by a user of the self-sealing ear-tip assembly 100. Although the method steps of FIG. 10 are described with respect to the self-sealing ear-tip assembly 100 of FIGS. 1A-B, many ways of inserting a self-sealing ear-tip assembly including the method steps, in any order, can fall within the scope of the various embodiments.

As shown, a method 1000 begins at step 1002 in which a user inserts a part of a rigid insert into a longitudinal channel of a sleeve. For example and without limitation, the user can insert the rigid insert into the sleeve until a position of a first portion of an outer surface of the rigid insert corresponds to a position of a first portion of an inner surface of the longitudinal channel. Inserting part of the rigid insert can couple the rigid insert with the sleeve as an assembly, without causing the outer surface of the sleeve to expand in a cross-sectional size in at least one direction. An example of this configuration is shown on the left in FIG. 8B.

At step 1004, the user inserts the sleeve into an ear canal of the user. For example, the user can position the sleeve at a desired insertion depth and/or orientation within the ear canal that is comfortable for the user. The sleeve to be inserted can be selected from among a set of sleeves of various sizes, shapes, and/or materials, e.g., to fit an ear canal of the user.

At step 1006, the user further inserts the rigid insert into the longitudinal channel of the sleeve to cause at least a portion of the outer surface of the sleeve to expand in a cross-sectional size in at least one direction. The rigid insert can be inserted, e.g., by pushing the rigid insert into the ear canal in an insertion direction, and/or by holding the rigid insert while pulling the sleeve toward the rigid insert.

FIG. 11 illustrates a flow diagram of method steps for removing a self-sealing ear-tip assembly, according to various embodiments. The method steps of FIG. 11 can be applied, e.g., by a user of the self-sealing ear-tip assembly 100. Although the method steps of FIG. 11 are described with respect to the self-sealing ear-tip assembly 100 of FIGS. 1A-B, many ways of removing a self-sealing ear-tip assembly including the method steps, in any order, can fall within the scope of the various embodiments.

As shown, a method 1100 begins at step 1102 in which a user at least partially withdraws a rigid insert from a longitudinal channel of a sleeve to cause at least a portion of an outer surface of the sleeve to contract in a cross-sectional size in at least one direction. The rigid insert can be withdrawn, e.g., by pulling the rigid insert from the ear canal opposite the insertion direction.

At step 1104, the user removes the sleeve from the ear canal. The user can reposition the sleeve at a different position within the ear canal, reinsert the sleeve, and/or insert a different sleeve into the ear canal.

In sum, in-ear headphones can be designed to expand in a cross-sectional size in at least one direction when a rigid insert of an earbud is inserted into a sleeve. The sleeve is inserted into an ear canal of a user at a desired position, and a rigid insert of the earbud is inserted into the sleeve, causing the cross-sectional size of at least a portion of the sleeve to expand in at least one direction. This expanding causes the sleeve to fill and fit the ear canal, which improves a seal between the sleeve and the ear canal and reduces the accidental withdrawal of the assembly from the ear canal. Withdrawal of the assembly causes the cross-sectional size of at least the portion of the sleeve to contract in the at least one direction, which allows the user to reposition the assembly or remove the sleeve.

At least one technical advantage of the disclosed techniques relative to the prior art is that, with the disclosed techniques, an improved fit between each assembly and the ear canal of the user increases the retention of the assembly, and the assembly is less likely to be dislodged, particularly during physical activity. The ability of the assembly to collapse in a cross-sectional size in at least one direction improves the comfort and ease of inserting and removing the earbud and enables the user to position each earbud at a desired depth. The adaptability of the cross-sectional expansion of the assembly to different shapes improves the ability of the assembly to fit the differently-shaped ear canals of a variety of users. The increased fit reduces audio leakage, thus preserving audio quality and, in some cases, the effectiveness and efficiency of active noise cancellation. As a result, an improved and/or ideal seal in the ear canal of the user is enabled. Thus, the user can better enjoy music and other content in full bandwidth. Yet another advantage is that the assembly is durable, reusable, and easy to clean. Yet another advantage is that the manufacturing complexity of the assembly as described herein is low, particularly when compared to the manufacturing of customized ear buds. Yet another advantage is that operation of the assembly as described herein is easy for an average user. That is, no specialized knowledge or training is needed to achieve the improved or ideal seal in the ear canal of the user. These technical advantages provide one or more technological improvements over prior art in-ear headphones.
1. In some embodiments, an apparatus comprises an audio generating element, a sleeve including a longitudinal channel, an outer surface of the sleeve including at least a first portion that is expandable in a cross-sectional size in at least one direction, and a rigid insert configured for insertion into the longitudinal channel, wherein at least the first portion of the outer surface of the sleeve expands in the at least one direction when the rigid insert is inserted into the longitudinal channel.
2. The apparatus of clause 1, wherein expanding the cross-sectional size in the at least one direction of at least the first portion of the outer surface of the sleeve when the apparatus is inserted into an ear canal of a user creates a seal within the ear canal of the user.
3. The apparatus of clauses 1 or 2, wherein the outer surface of the sleeve has a cylindrical shape with a cylindrical radius when the rigid insert is not inserted into the longitudinal channel, and the cross-sectional size in the at least one direction of the first portion of the outer surface of the sleeve is larger than the cylindrical radius when the rigid insert is inserted into the longitudinal channel.
4. The apparatus of any of clauses 1-3, wherein the cross-sectional size of the first portion of the outer surface of the sleeve in the at least one direction is smaller than a cross-sectional size in the at least one direction of a second portion of the outer surface of the sleeve when the rigid insert is not inserted into the longitudinal channel, and the cross-sectional size of the first portion of the outer surface of the sleeve is at least the cross-sectional size of the second portion of the outer surface of the sleeve when the rigid insert is inserted into the longitudinal channel.
5. The apparatus of any of clauses 1-4, wherein a cross-sectional size in the at least one direction of a first portion of an outer surface of the rigid insert is larger than a cross-sectional size in the at least one direction of a first portion of an inner surface of the longitudinal channel.
6. The apparatus of clause 5, wherein a cross-sectional size in the at least one direction of a second portion of an outer surface of the rigid insert is smaller than the cross-sectional size in the at least one direction of the first portion of the outer surface of the rigid insert.
7. The apparatus of clause 6, wherein the first portion of the outer surface of the rigid insert is closer to a distal end of the rigid insert than the second portion of the outer surface of the rigid insert.
8. The apparatus of clause 7, wherein a cross-sectional size in the at least one direction of the first portion of an inner surface of the longitudinal channel is smaller than the cross-sectional size in the at least one direction of the first portion of the outer surface of the rigid insert, and the first portion of the outer surface of the rigid insert is closer to the distal end of the rigid insert than the first portion of the inner surface of the longitudinal channel when the rigid insert is inserted into the longitudinal channel.
9. The apparatus of clause 5, wherein a second portion of the outer surface of the rigid insert is at a different position along an insertion axis of the rigid insert than the first portion of the outer surface of the rigid insert, and the cross-sectional size in the at least one direction of the second portion of the outer surface of the rigid insert is at least as large as the cross-sectional size in the at least one direction of the first portion of the outer surface of the rigid insert.
10. The apparatus of clause 9, wherein a third portion of the outer surface of the rigid insert is between the first portion of the outer surface of the rigid insert and the second portion of the outer surface of the rigid insert along the insertion axis, and a cross-sectional size in the at least one direction of a third portion of the outer surface of the rigid insert is smaller than the cross-sectional size in the at least one direction of the first portion of the outer surface of the rigid insert and the second portion of the outer surface of the rigid insert.
11. The apparatus of clause 10, wherein a cross-sectional size in the at least one direction of the third portion of the outer surface of the rigid insert is larger than a cross-sectional size in the at least one direction of a third portion of the inner surface of the longitudinal channel, and a position of the third portion of the outer surface of the rigid insert corresponds to the third portion of the inner surface of the longitudinal channel when the rigid insert is inserted into the longitudinal channel.
12. The apparatus of clause 11, wherein, when a position of the first portion of the outer surface of the rigid insert corresponds to a position of the first portion of the inner surface of the longitudinal channel, the third portion of the inner surface of the longitudinal channel resists withdrawal of the rigid insert from the sleeve.
13. The apparatus of clause 11, wherein, when the rigid insert is inserted into the longitudinal channel, the third portion of the inner surface of the longitudinal channel creates pressure against the third portion of the outer surface of the rigid insert, and the pressure secures the rigid insert within the longitudinal channel.
14. The apparatus of clause 5, wherein a second portion of the outer surface of the rigid insert is at a different position along an insertion axis of the rigid insert than the first portion of the outer surface of the rigid insert, a second portion of the inner surface of the longitudinal channel is at a different position along the insertion axis of the longitudinal channel than the first portion of the inner surface of the longitudinal channel, and a cross-sectional size in the at least one direction of the second portion of the inner surface of the longitudinal channel is at least as large as a cross-sectional size in the at least one direction of the second portion of the outer surface of the rigid insert.
15. The apparatus of clause 14, wherein, when the rigid insert is partially inserted into the longitudinal channel, a position of the first portion of the outer surface of the rigid insert along the insertion axis corresponds to a position of the first portion of the inner surface of the longitudinal channel along the insertion axis and causes the first portion of the sleeve to expand to a first cross-sectional size in the at least one direction, and when the rigid insert is further inserted into the longitudinal channel, a position of the second portion of the outer surface of the rigid insert along the insertion axis corresponds to the position of the first portion of the inner surface of the longitudinal channel along the insertion axis and causes the first portion of the sleeve to expand to a second cross-sectional size in the at least one direction that is larger than the first cross-sectional size.
16. The apparatus of clause 15, wherein expanding the first portion of the sleeve to the first cross-sectional size when the apparatus is inserted into an ear canal of a user creates a first seal within the ear canal of the user; and expanding the first portion of the sleeve to the second cross-sectional size when the apparatus is inserted into the ear canal of the user creates a second seal within the ear canal of the user that is tighter than the first seal.
17. The apparatus of clause 5, wherein a cross-sectional size in the at least one direction of a tapered portion of the outer surface of the rigid insert monotonically increases along an insertion axis of the rigid insert, the tapered portion is closer to a distal end of the rigid insert than the first portion of the outer surface of the rigid insert, and the cross-sectional size of the tapered portion in the at least one direction monotonically decreases along the insertion axis in an insertion direction.
18. The apparatus of any of clauses 1-17, wherein at least a portion of an inner surface of the longitudinal channel has a different cross-sectional size in a first direction than in a second direction, and at least a portion of an outer surface of the rigid insert has a different cross-sectional size in the first direction than in the second direction.
19. The apparatus of any of clauses 1-18, wherein an inner surface of the longitudinal channel has a first alignment element, and an outer surface of the rigid insert has a second alignment element configured to couple with the first alignment element when the rigid insert is inserted into the longitudinal channel.
20. The apparatus of any of clauses 1-19, further comprising at least one of a wired connection configured to couple the audio generating element to an audio source or an audio receiver configured to cause the audio generating element to generate audio based on an audio signal received from an audio source.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

While the preceding is directed to embodiments of the present disclosure, other and further embodiments of the disclosure can be devised without departing from the basic scope thereof, and the scope thereof is determined by the claims that follow.

What is claimed is:

1. An apparatus, comprising:
an audio generating element;
a sleeve including a longitudinal channel, an outer surface of the sleeve including at least a first portion that is expandable in a cross-sectional size in at least one direction; and
a rigid insert configured for insertion into the longitudinal channel,
wherein at least the first portion of the outer surface of the sleeve expands in the at least one direction when the rigid insert is inserted into the longitudinal channel.

2. The apparatus of claim 1, wherein expanding the cross-sectional size in the at least one direction of at least the first portion of the outer surface of the sleeve when the apparatus is inserted into an ear canal of a user creates a seal within the ear canal of the user.

3. The apparatus of claim 1, wherein the outer surface of the sleeve has a cylindrical shape with a cylindrical radius when the rigid insert is not inserted into the longitudinal channel, and the cross-sectional size in the at least one direction of the first portion of the outer surface of the sleeve is larger than the cylindrical radius when the rigid insert is inserted into the longitudinal channel.

4. The apparatus of claim 1, wherein the cross-sectional size of the first portion of the outer surface of the sleeve in the at least one direction is smaller than a cross-sectional size in the at least one direction of a second portion of the outer surface of the sleeve when the rigid insert is not inserted into the longitudinal channel, and the cross-sectional size of the first portion of the outer surface of the sleeve is at least the cross-sectional size of the second portion of the outer surface of the sleeve when the rigid insert is inserted into the longitudinal channel.

5. The apparatus of claim 1, wherein a cross-sectional size in the at least one direction of a first portion of an outer surface of the rigid insert is larger than a cross-sectional size in the at least one direction of a first portion of an inner surface of the longitudinal channel.

6. The apparatus of claim 5, wherein a cross-sectional size in the at least one direction of a second portion of an outer surface of the rigid insert is smaller than the cross-sectional size in the at least one direction of the first portion of the outer surface of the rigid insert.

7. The apparatus of claim 6, wherein the first portion of the outer surface of the rigid insert is closer to a distal end of the rigid insert than the second portion of the outer surface of the rigid insert.

8. The apparatus of claim 7, wherein a cross-sectional size in the at least one direction of the first portion of an inner surface of the longitudinal channel is smaller than the cross-sectional size in the at least one direction of the first portion of the outer surface of the rigid insert, and the first portion of the outer surface of the rigid insert is closer to the distal end of the rigid insert than the first portion of the inner surface of the longitudinal channel when the rigid insert is inserted into the longitudinal channel.

9. The apparatus of claim 5, wherein a second portion of the outer surface of the rigid insert is at a different position along an insertion axis of the rigid insert than the first portion of the outer surface of the rigid insert, and the cross-sectional size in the at least one direction of the second portion of the outer surface of the rigid insert is at least as large as the cross-sectional size in the at least one direction of the first portion of the outer surface of the rigid insert.

10. The apparatus of claim 9, wherein a third portion of the outer surface of the rigid insert is between the first portion of the outer surface of the rigid insert and the second portion of the outer surface of the rigid insert along the insertion axis, and a cross-sectional size in the at least one direction of a third portion of the outer surface of the rigid insert is smaller than the cross-sectional size in the at least one direction of the first portion of the outer surface of the rigid insert and the second portion of the outer surface of the rigid insert.

11. The apparatus of claim 10, wherein a cross-sectional size in the at least one direction of the third portion of the outer surface of the rigid insert is larger than a cross-sectional size in the at least one direction of a third portion of the inner surface of the longitudinal channel, and a position of the third portion of the outer surface of the rigid insert corresponds to the third portion of the inner surface of the longitudinal channel when the rigid insert is inserted into the longitudinal channel.

12. The apparatus of claim 11, wherein, when a position of the first portion of the outer surface of the rigid insert corresponds to a position of the first portion of the inner surface of the longitudinal channel, the third portion of the inner surface of the longitudinal channel resists withdrawal of the rigid insert from the sleeve.

13. The apparatus of claim 11, wherein, when the rigid insert is inserted into the longitudinal channel, the third portion of the inner surface of the longitudinal channel creates pressure against the third portion of the outer surface of the rigid insert, and the pressure secures the rigid insert within the longitudinal channel.

14. The apparatus of claim 5, wherein a second portion of the outer surface of the rigid insert is at a different position along an insertion axis of the rigid insert than the first portion of the outer surface of the rigid insert, a second portion of the inner surface of the longitudinal channel is at a different position along the insertion axis of the longitudinal channel than the first portion of the inner surface of the longitudinal channel, and a cross-sectional size in the at least one direction of the second portion of the inner surface of the longitudinal channel is at least as large as a cross-sectional size in the at least one direction of the second portion of the outer surface of the rigid insert.

15. The apparatus of claim 14, wherein, when the rigid insert is partially inserted into the longitudinal channel, a position of the first portion of the outer surface of the rigid insert along the insertion axis corresponds to a position of the first portion of the inner surface of the longitudinal channel along the insertion axis and causes the first portion of the sleeve to expand to a first cross-sectional size in the at least one direction, and when the rigid insert is further inserted into the longitudinal channel, a position of the second portion of the outer surface of the rigid insert along the insertion axis corresponds to the position of the first portion of the inner surface of the longitudinal channel along the insertion axis and causes the first portion of the sleeve to expand to a second cross-sectional size in the at least one direction that is larger than the first cross-sectional size.

16. The apparatus of claim 15, wherein:
expanding the first portion of the sleeve to the first cross-sectional size when the apparatus is inserted into an ear canal of a user creates a first seal within the ear canal of the user; and
expanding the first portion of the sleeve to the second cross-sectional size when the apparatus is inserted into the ear canal of the user creates a second seal within the ear canal of the user that is tighter than the first seal.

17. The apparatus of claim 5, wherein a cross-sectional size in the at least one direction of a tapered portion of the outer surface of the rigid insert monotonically increases along an insertion axis of the rigid insert, the tapered portion is closer to a distal end of the rigid insert than the first portion of the outer surface of the rigid insert, and the cross-sectional size of the tapered portion in the at least one direction monotonically decreases along the insertion axis in an insertion direction.

18. The apparatus of claim 1, wherein at least a portion of an inner surface of the longitudinal channel has a different cross-sectional size in a first direction than in a second direction, and at least a portion of an outer surface of the rigid insert has a different cross-sectional size in the first direction than in the second direction.

19. The apparatus of claim 1, wherein an inner surface of the longitudinal channel has a first alignment element, and an outer surface of the rigid insert has a second alignment element configured to couple with the first alignment element when the rigid insert is inserted into the longitudinal channel.

20. The apparatus of claim 1, further comprising at least one of a wired connection configured to couple the audio generating element to an audio source or an audio receiver configured to cause the audio generating element to generate audio based on an audio signal received from an audio source.
